(19) United States
(12) Patent Application Publication
(10) Pub. No.: US 2011/0099359 A1
(43) Pub. Date: Apr. 28, 2011

(54) Controlling A Device's Boot Path With Disk Locking

(76) Inventor: Douglas E. O'Neil, Auburn, CA (US)

(21) Appl. No.: 12/605,707

(22) Filed: Oct. 26, 2009

(51) Int. Cl. G06F 9/00; G06F 12/00

(52) U.S. Cl. 713/2; 714/25; 711/154

(57) ABSTRACT

The computing system whose boot path is controlled by data locking comprised of: a processing device capable of executing instructions, including BIOS instructions for determining the booting priority of at least an application memory storage device and a services memory storage device, wherein the applications memory storage device and the services memory storage device are electrically coupled to the processing device, wherein the BIOS instructions set the booting priority of the services memory storage device higher than the priority of the application memory storage device and wherein the services memory storage device is capable of being locked and unlocked.

### BACKGROUND

Diagnosing and repairing a computer system that has failed to boot typically requires on-site human interaction by a trained technician. This can cause significant expense and down time, especially if the site is not staffed with an appropriate technician at the time of the failure. When diagnosing the system, it is common for the technician to reboot the affected computer from a separate external Thumb Drive, a Floppy Drive or a CD ROM utility disk that he/she has brought with them. The Thumb Drive, Floppy Drive or CD ROM typically contains diagnostic, file repair, anti-virus and/or total system recovery utilities. Often the problem is caused by data corruption of the boot disk and can be remedied by the utilities provided within the Utility Disk without replacement of any hardware.

Disk corruption is a common problem in memory storage devices and thus a common problem for computer systems. One method of solving a suspected problem of disk corruption is to have a dedicated Rescue Partition (RP) on the same disk which includes the Application Partition (AP). This method requires a human technician with physical access to the computer system to enter a BIOS menu or to enter an alternative boot choice to use the Rescue Partition to restore the Application Partition with an “as-shipped” image that is stored within the RP. Unfortunately, this method does not work when the Rescue Partition has been corrupted due to the same event that corrupted the Application Partition. It also does not work when the common disk has a physical failure. It also has the disadvantage of requiring a local technician with physical access to the system.

A solution is needed whereby which minimizes or eliminates the use of an on-site service technician for common device error problems, thereby decreasing downtime and maintenance manpower costs.

### BRIEF DESCRIPTION OF THE DRAWINGS

The figures depict implementations/embodiments of the invention and not the invention itself. Some embodiments of the invention are described, by way of example, with respect to the following Figures:

FIG. 1 shows a block diagram of the computing system in accordance with embodiments of the present invention.

FIG. 2 shows a flow chart of the method of controlling a computing systems boot path with Disk Locking in accordance with embodiments of the present invention.

### DETAILED DESCRIPTION

The present invention describes a computing system whose boot path is controlled by Disk Locking. The computing system 100 comprised of: a processing device 106 capable of executing instructions, including BIOS instructions for determining the booting priority of at least an application memory storage device 114 and a services memory storage device 118, wherein the applications memory storage device 114 and the services memory storage device 118 are electrically coupled to the processing device 106, wherein the BIOS instructions set the booting priority of the services memory storage device 118 higher than the priority of the application memory storage device 114, and wherein the services memory storage device 118 is capable of being locked and unlocked.

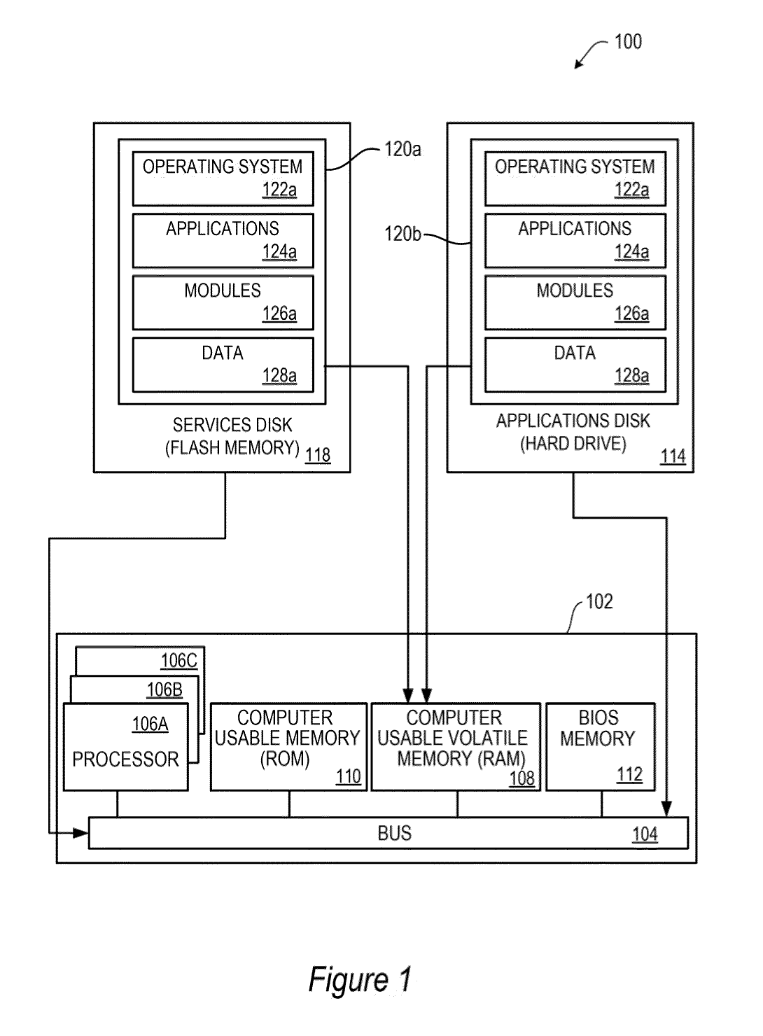

FIG. 1 is a block diagram of an example computing system 100 in accordance with embodiments of the present invention. The computing system 100 of FIG. 1 includes an address/data bus 104 for communicating information, and a processor 106A coupled to bus 104 for processing information and instructions. Also coupled to bus 104, are the application memory storage device 114 (also known as the Applications Disk) and the services memory storage device 118 (also known as the Services Disk). In one embodiment, the Applications Disk 114 is a hard disk (e.g. a magnetic or optical disk or disk drive). In one embodiment, the Services Disk 118 is a writeable non-volatile memory device (e.g. a flash memory).

The computing system 100 includes at least two physical disks which are electrically coupled to the computing system at all times. The first disk is the Services Disk (SD) 118 and the second disk is the Applications Disk (AD) 114. The Services Disk 118 is a bootable disk that may contain, but is not limited to, an operating system (OS) and a diagnostic utility to: identify potential problems, repair utilities to fix issues that can be fixed via software (such as many file system errors), backup and store utilities. The second disk is the Application Disk (AD) is a bootable disk that typically contains, but is not limited to, the OS and the applications that are operated on by the computing system during normal operations.

The computing device 102 also includes: a computer usable non-volatile memory 110, e.g. read-only-memory (ROM) coupled to bus 104 for storing information and instructions. Also present in computing device 102 is a BIOS memory storage device 112 coupled to bus 104 that stores BIOS instructions.

The BIOS instructions are executed by the processor 106 and determine the booting priority of the devices. In implementing the present invention, the booting priority of the Services Disk is always higher than the booting priority of the Applications Disk 114. During normal operation, the Service Disk 118 is locked. However since the Applications Disk is always set to have a lower priority than the Services Disk, by unlocking the Service Disk, the service technician can selectively decide to boot from the Service Disk. Typically, this option is exercised when the service technician wishes to run diagnostic programs.

FIG. 1 illustrates an example computing system 100 including a computing device 102 used in accordance with embodiments of the present invention. It is appreciated that computing system 100 of FIG. 1 is an example only and that embodiment of the present technology can operate on or within a number of different computer systems including general purpose networked computer systems, embedded computer systems, routers, switches, server devices, user devices, various intermediate devices/artifacts, stand alone computer systems, and the like.

In one embodiment, the computing system 100 is a network switch or router that is capable of capable of communicating over a network. In one embodiment, the communication is from the computing device 102 to a service technician who is physically located in a remote location. The service technician is able to input commands to the computing device 110 to unlock the Services Disk 118. Diagnostic programs stored on the Services Disk 118 can be run to determine problems within the computing system 100.

The Services Disk 118 is capable of being locked or unlocked. This “locking” feature is an industry standard feature that is built into many flash and hard drives. In one embodiment, the Services Disk uses the ATA “Disk Locking” feature. In conventional implementations, the locking feature is used to lock the disk during normal operations. The “locking” feature in the present invention is used in a non-standard way, to allow a management entity and/or the service technician to control which disk (114 or 118) is used to boot up the computing system 100.

The locking feature of the Services Disk can be used to designate and allow the Services Disk to be used as a backup disk for the computing system 100. In this embodiment (where the Service Disk is used a backup for the Applications Disk), the Services Disk itself contains a backup copy of the operating system and/or the applications that are normally stored and used by the computing device. In this case, copies of the operating system 122a, applications 124a, modules 126a that reside on the Applications Disk also reside on Services Disk (see 122b, 124b, 126b).

Inclusion of the operating system program 122, the applications 124 and modules 126 on the Service Disk is optional and not required for modification of the booting priority using the disk locking technology as described. However, inclusion of the operating system and applications would allow the computing system to perform it's normal functions, even when there is a catastrophic failure of the Applications Disk. In this instance, the described technology provides improved availability since the second “locked” disk is used as a standby backup for the Application Disk.

The fact that the Services Disk is locked means that it is protected from being corrupted by anything running on the Applications Disk. Because it is locked, the Service Disk is isolated from the computing system when the system is booted from the Applications Disk 118. This makes it safe from any deleterious actions, whether intentional or accidental, that occur when the booted Application Disk is compromised or damaged. Therefore if, for example, there a corrupted file system on the Applications Disk, the management entity or service technician can use the Services Disk to fix, repair or declare dead the Applications Disk. Further, when the Service Disk includes copies of the programs on the Applications Disk, the Service Disk is capable of completely re-initializing the Applications Disk or saving data to the Application Disk if needed.

In normal operation, the Services Disk 118 is locked and cannot be unlocked unless given a password. The BIOS instructions set the boot priority of the Service Disk so that it is always higher than the boot priority of the Applications Disk. Therefore, if the Service Disk is not given a password (the case for normal operations), then the computing device boots from the Applications Disk. For this case (normal operation), the Services Disk is taken out of the system as a useable device.

In one embodiment, the computing system 100 includes a management entity which controls whether the Services Disk receives a password that allows it to be unlocked. In one embodiment, service technician communicates with the management entity that the Services Disk should be provided a password that will unlock the SD. In another embodiment, predetermined conditions will automatically trigger providing of a password (from the management entity) to the SD—without the manual intervention of a service technician. These predetermined conditions are often service issues (for example, file error on AD, read head error on AD, etc.) which would require the computer system to be rebooted and possibly replacement of computer system components.

The Service Disk is only unlocked when it is selected to be the boot device for the computer. Because the Service Disk is connected to both the Applications Disk and the computing device, once the Service Disk is booted, it is free to access both itself, the Applications Disk and the computing device to determine if the computing system has and is currently operating satisfactorily.

The computing device 102 is physically connected to both the Applications Disk 114 and the Services Disk 118. Because it is connected to both disks, the processing device can still see the data on the Applications Disk (or on the Services Disk)—even if was booted from the Services Disk and running on the Services Disk. Data either on the Applications Disk or Services Disk—is just data to the CPU. The Services Disk typically includes diagnostic programs for diagnosing performance problems in the computing system. In one embodiment, the Services Disk includes anti-virus software. In this case, the computing system can scan the Application Disk, the Services Disk or itself for viruses.

Embodiments of the present technology may be described in the general context of computer-executable instructions, such as program modules, being executed on a computer. Generally, program modules include routines, programs, objects, components, data structures, etc. that perform particular tasks or implement particular abstract data types. Embodiments of the present technology may also be practiced in distributed computing environments where tasks are performed by remote processing devices that are linked through a communications network. In one embodiment, the communication is over a communications network, via for example coupling to the interne, from the computing device 102 to a service technician who is physically located in a remote location.

Exercising the locking mechanism on the Services Disk in combination with the preset boot priority (booting priority of the Service Disk is higher than the booting priority of Application Disk), allows the management entity or service technician to selectively decide when to boot the Services Disk. If connected to a communications network, the described implementation (OS loaded onto SD, computing device electrically connected to both AD and SD) allows an off-site technician to access the computing system remotely and run diagnostics on the SD to determine potential problems with the computing system. The ability to access the computing system remotely minimizes a problem associated with past solution—the expense associated with an on-site technician.

Because the AD and SD are both physically connected to the computing device, the service technician can observe data from both the AD, SD and itself Based on the information it receives from running diagnostic programs, the technician can run programs in order to attempt to repair the computing system remotely. If the computing system cannot be repaired satisfactorily remotely, the service technician is at least aware of the diagnostic results prior to visiting the site. This makes it more likely that the service technician will arrive at the site carrying the proper replacement parts, etc.

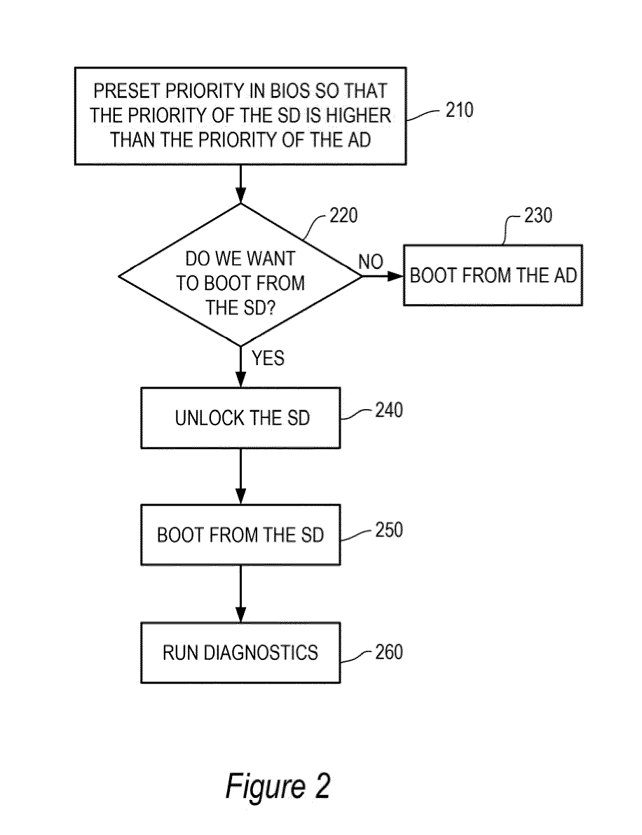

FIG. 2 shows a flow chart of the method of controlling a computing systems boot path with disk locking in accordance with embodiments of the present invention. Referring to FIG. 2, the first step in the method of controlling the computing systems boot path is to preset the BIOS so that the priority of the Service Disk is higher than the priority of the Applications Disk (step 210). This step is done before booting the computing system.

The BIOS first looks to see what bootable devices are available. For the present implementation, the BIOS will find at least an Applications Disk and a Service Disk to as potential bootable devices. The boot priority that is set within the BIOS such that it will always attempt to boot the Service Disk before it attempts to boot the Application Disk. The computing system determines if it should boot to the SD or the AD (step 220). A “normal” boot would be the boot to the Application Disk (step 230). To do this, the Service Disk would remain locked, which would cause it to fail that boot. The system would then fail over and boot the Application Disk. With the Service Disk remaining locked, it's contents would be immune to any accidental or intentional damage caused by the Application Disk's Operating system, application, or any malicious programs that may have found their way into the Applications Disk.

If the management entity (or service technician) wishes to unlock the Services Disk (step 240), it must provide a password to unlock the SD. If the SD is unlocked, the computing device will boot from the Services Disk 250. Typically, it is desirable to run diagnostic programs (step 260) that are typically available on the Services Disk. If after running diagnostics it is determined that the Applications Disk is corrupted, the management entity may keep the Services Disk unlocked if backup programs are available on the Services Disk, run from the Services Disk instead of the Applications Disk until a new Applications Disk can be installed by a services technician.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. For example, as depicted in FIG. 1, system 100 is also well suited to a multi-processor environment in which a plurality of processors 106A, 106B, 106C are present. Conversely, computing system 100 is also well suited to having a single processor such as, for example, processor 106A. Processors 106A, 106B, 106C may be any of various types of microprocessors. System 100 also includes data storage features such as a computer usable volatile memory 108, e.g. random access memory (RAM), coupled to bus 104 for storing information and instructions for processors 106A, 106B, and 106C. Further, Device 100 is only one example of a suitable computing environment and is not intended to suggest any limitation as to the scope or functionality of embodiments of the present technology. Neither should the computing environment 100 be interpreted as having any dependency or requirement relating to any one or combination of components illustrated in the example computing system 100.

The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A computing system whose boot path is controllable by disk locking, comprised of:
a processing device capable of executing instructions including BIOS instructions for determining the booting priority of at least an application memory storage device and a services memory storage device,
wherein the applications memory storage device and the services memory storage device are electrically coupled to the processing device,
wherein the BIOS instructions set the booting priority of the services memory storage device higher than the priority of the application memory storage device, and wherein the services memory storage device is capable of being locked and unlocked.

2. The computing system in claim 1 wherein an operating system program and an applications program are stored on the applications memory storage device and a diagnostic program is stored on the services memory storage device.

3. The computing system recited in claim 2 further including an operating system program stored on the services memory device.

4. The computing system recited in claim 3 wherein the operating system program on the applications memory storage device is the same operating systems program on the services memory storage device.

5. The computing system recited in claim 4 wherein when unlocked the services memory storage device acts as a backup disk for the computing system.

6. The computing system recited in claim 1 wherein the services memory storage device is locked when the computing system is booted from the application memory storage device to isolate and protect the services memory storage device from being corrupted.

7. The computing system recited in claim 1 wherein unlocking of the services memory storage device is initiated by sending the service memory storage device a password.

8. The computing system recited in claim 7 wherein sending a password is triggered automatically by meeting predetermined conditions.

9. The computing system recited in claim 7 wherein the command to send a password is sent by a services technician for the express purpose of controlling which storage device the processor is to boot from.

10. The computing system recited in claim 9, wherein the service technician is physically located at a remote location.

11. A computer readable storage medium having computer-readable program instructions stored thereon for causing a computer system to perform a method of booting, the method comprising the steps of:
determining the booting priority of at least an application memory storage device and a services memory storage device,
wherein the applications memory storage device and the services memory storage device are electrically coupled to the processing device,
wherein the BIOS instructions set the booting priority of the services memory storage device higher than the priority of the application memory storage device, and wherein the services memory storage device is capable of being locked and unlocked; and
booting to the memory storage device that has the highest booting priority and that is also unlocked.

12. The computer readable storage media recited in claim 11 wherein an operating system program and an applications program are stored on the applications memory storage device and a diagnostic program is stored on the services memory storage device.

13. The computer readable storage media recited in claim 12 further including an operating system program stored on the services memory device.

14. The computer readable storage media recited in claim 13 wherein the operating system program on the applications memory storage device is the same operating systems program on the services memory storage device.

15. The computer readable storage media recited in claim 14 wherein when unlocked, the services memory storage device acts as a backup disk for the computing system.

16. The computer readable storage media recited in claim 11 wherein the services memory storage device is locked when the computing system is booted from the application memory storage device to isolate and protect the services memory storage device from being corrupted.

17. The computer readable storage media recited in claim 11 wherein unlocking of the services memory storage device is initiated by sending the service memory storage device a password.

18. The computer readable storage media recited in claim 17 wherein sending a password is triggered automatically by meeting predetermined conditions.

19. The computer readable storage media recited in claim 17 wherein the command to send a password is sent by a services technician.

20. A computing system whose boot path is controllable by data locking comprised of:
a processing device capable of executing instructions, including BIOS instructions for determining the booting priority of at least a first memory storage device and a second memory storage device,
wherein the first memory storage device and the second memory storage device are electrically coupled to the processing device, wherein the BIOS instructions set the booting priority of the second memory storage device higher than the priority of the first memory storage device, and wherein the first memory storage device is capable of being locked and unlocked.
